(19) United States
(12) Patent Application Publication
(10) Pub. No.: US 2020/0063762 A1
(43) Pub. Date: Feb. 27, 2020

(54) Spinning Machine or Winder and Method for Operating a Spinning Machine or Winder

(71) Applicant: Maschinenfabrik Rieter AG, Winterthur (CH)

(72) Inventor: Robert Hagl, Rottenegg (DE)

(21) Appl. No.: 16/546,839

(22) Filed: Aug. 21, 2019

(30) Foreign Application Priority Data
Aug. 21, 2018 (DE) 10 2018 120 322.5

(51) Int. Cl. F15B 13/04; D01H 9/18

(52) U.S. Cl. CPC F15B 13/0401; D01H 9/18; F15B 2211/30525; F15B 2211/6653; F15B 2211/253; F15B 2211/212

(57) ABSTRACT

In a spinning machine or winder comprising at least one pneumatic device (7) including a supply line (8) for a first pressure (P₁), a regulating line (9) for an operating pressure (P₂), a valve system (10), a manometer (13), and a data processing unit (14), the regulating line (9) is connected to the manometer (13) in such a way that the operating pressure (P₂) is measured by the manometer (13). The valve system (10) comprises a first valve (11), which is connected to the supply line (8), or a first path (17) of a directional control valve (16) for feeding a pressure medium into the regulating line (9), and a second valve (12), which is connected to a surrounding atmosphere, or a second path (18) of a directional control valve (16) for draining the pressure medium from the regulating line (9), wherein the data processing unit (14), which is connected to the manometer (13) and to the valve system (10), is designed for
opening the first valve (11) or the first path (17) and closing the second valve (12) or the second path (18) if the operating pressure (P₂) is less than a first set value, and
opening the second valve (12) or the second path (18) and closing the first valve (11) or the first path (17) if the operating pressure (P₂) is greater than the first set value or a second set value, wherein the first pressure (P₁) is greater than the operating pressure (P₂).

The present invention relates to a spinning machine or winder comprising at least one pneumatic device including a supply line for a first pressure, a regulating line for an operating pressure, a valve system, a manometer, and a data processing unit, wherein the regulating line is connected to the manometer in such a way that the operating pressure is measured by the manometer.

Moreover, the invention relates to a method for operating a spinning machine or winder, wherein an operating pressure is regulated in a regulating line of a pneumatic device of the spinning machine or winder, wherein the operating pressure is measured by a manometer and is compared, by a data processing unit, to at least one set value.

Spinning machines for processing slivers into threads are generally known. The methods, according to which these machines operate, include, inter alia, ring spinning, rotor spinning, or air-jet spinning. Regardless of the spinning method, the spinning machines generally comprise a winding unit, in which the produced yarn is wound onto bobbins. In addition, winders are known, which, for example, rewind a thread from one bobbin to another bobbin. Winders and winding units of spinning machines often comprise pneumatically operating components, such as the package loading device described in DE 100 62 937 B4. In this case, a drive roller is pressed onto a package pneumatically, for example, with the aid of a pneumatic cylinder, with a variable contact pressure. In addition, modern spinning machines or winders comprise a plurality of workstations, which occasionally operate independently of one another. The pressure regulation of the pneumatic components often takes place centrally in this case, which makes it nearly impossible to adapt to individual working conditions at the workstations or at different areas of the spinning machines or winders.

The problem addressed by the present invention is therefore that of improving the pressure regulation in spinning machines or winders.

The problem is solved by a spinning machine or winder and a method having the features of the independent claims.

The spinning machine or winder according to the invention comprises at least one pneumatic device, wherein the pneumatic device includes a supply line for a first pressure, a regulating line for an operating pressure, a valve system, a manometer, and a data processing unit. The regulating line is connected to the manometer in such a way that the operating pressure is measured by the manometer.

It is provided that the valve system comprises a first valve, which is connected to the supply line, or a first path of a directional control valve for feeding a pressure medium into the regulating line, and a second valve, which is connected to a surrounding atmosphere, or a second path of a directional control valve for draining the pressure medium from the regulating line. The data processing unit, which is connected to the manometer and to the valve system, is designed for opening the first valve or the first path and closing the second valve or the second path if the operating pressure is less than a first set value. In addition, the data processing unit is designed for opening the second valve or the second path and closing the first valve or the first path if the operating pressure is greater than the first set value or a second set value, wherein the first pressure is greater than the operating pressure.

The described pneumatic device can be designed to be highly compact. Therefore, it is possible to provide pressure regulation at different points of the spinning machines or winders. It is conceivable, for example, to regulate the operating pressure independently for each machine side, section, or workstation. In addition, the pneumatic device comprises a low number of components, which reduces the susceptibility to interference and enhances the serviceability. Costly, direct-controlled or precontrolled pressure regulating valves of the type usually utilized for pressure regulation can be saved as a result.

Air is an option as the pressure medium, wherein the air must be cleaned if it is obtained from the surroundings. A compressor, for example, is suitable for generating the first pressure. Alternatively, however, a pressure medium precompressed away from the spinning machine or winder and obtained from a pressure vessel, for example, a gas cylinder, is also conceivable.

The operating pressure regulated by the pneumatic device can be utilized, for example, for operating a pneumatic cylinder. The regulation of the pressure in a blower is also conceivable. In the simplest case, the data processing unit can be, for example, an integrated circuit. More complex data processing units, for example, in the form of a computer, are also conceivable, however.

The described valves or the described directional control valve can be, in particular, electrically actuated valves, wherein the data processing unit is designed, in particular, for generating an electrical control signal for actuating the valves.

The manometer is designed, in particular, for transmitting the measured pressure in the form of a proportional voltage signal to the data processing unit.

It is particularly advantageous when the data processing unit is also designed for closing the first valve or the first path and closing the second valve or the second path if the operating pressure is equal to the first set value or the operating pressure is between the first set value and the second set value. It is generally desirable to establish a certain pressure range for the operating pressure. Otherwise, a static state would never set in and the regulation would either increase or decrease the pressure at any time, which would result in a high loading of the components and high energy consumption. Pneumatically driven components also normally have a certain pressure tolerance. In order to establish the two set values, it is conceivable to provide the desired operating pressure with a certain tolerance range, from which the two set values result via addition and subtraction.

As has already been indicated, it is advantageous when the supply line is connected to a compressed air source. The compressed air source can be, for example, a compressor or a gas cylinder, which generate a constant pressure in the supply line. Air is particularly favorable as the pressure medium due to the low costs, the harmlessness, and the practically unlimited availability. It is conceivable to provide a central compressed air source for the supply lines of multiple pneumatic devices of a spinning machine or winder. Multiple compressed air sources can also be provided, for example, one for each section of the spinning machine or winder.

For the spinning machine or winder, it is particularly advantageous when the data processing unit is in control connection with a central machine control system. As a result, the pressure regulation can be centrally controlled and, in particular, coordinated with other control and/or measuring parameters of the spinning machine or winder. For example, a fully automated pressure regulation within the scope of a semi-automatic or fully automatic operation of the machine is conceivable.

In contemporary spinning machines or winders, a machine-wide data link is provided, into which the data processing unit can be easily integrated.

It is also conceivable, of course, to integrate the data processing unit into a section or workstation control system.

Moreover, it is advantageous to arrange the valve system and the manometer on a common circuit board. This reduces the amount of space required for the pneumatic device. In addition, an extensive wiring of the components can be dispensed with. A common power supply of the components can be provided, for example. It is conceivable, of course, to also arrange the data processing unit on the circuit board.

The valve system, the manometer, and the data processing unit can be designed as SMD (“surface mounted device”) components, and therefore the arrangement on a circuit board is particularly simple.

Advantageously, the first path and the second path extend within a directional control valve or within different directional control valves. When both paths extend in one valve, the complexity of the one valve increases, but a second valve can be dispensed with. When the paths extend in different valves, the smallest possible replaceable unit possibly generates lower costs with respect to maintenance.

When both paths extend within one valve, a 3/3 directional control valve is necessary as the minimum requirement. When the two paths extend in different valves, at least two 2/2 directional control valves are necessary. It is conceivable, of course, to utilize directional control valves comprising more couplings and/or paths. In particular, a 5/3 directional control valve is an option when only one valve is utilized and two 3/2 directional control valves is an option when multiple valves are utilized.

In a further advantageous embodiment, the spinning machine or winder comprises a plurality of workstations, which are arranged next to one another and have been combined to form sections, and multiple pneumatic devices, wherein at least one of the multiple pneumatic devices is arranged in each section. A mass production of yarn or the simultaneous winding of a plurality of threads is possible only with the aid of a plurality of workstations, which are possibly independent of one another. The workstations are generally grouped into functional units or sections, which have a common infrastructure. The working conditions and requirements can vary from section to section and, possibly, also from workstation to workstation, however, whereby a decentralized pressure regulation is advantageous.

It is conceivable to connect several of the pneumatic devices one behind the other in the manner of a cascade, wherein the regulating line of a first pneumatic device is simultaneously the supply line of a second pneumatic device.

In a further subdivision of each the sections into two section sides, it is advantageous when one of the multiple pneumatic devices is assigned to each section side, in each case.

As described above, it is advantageous to configure the pressure regulation to be decentralized. The smallest unit of a common pressure regulation determines the extent of possible individualization. It is therefore also conceivable, of course, that multiple pneumatic devices are assigned to each section side.

It is particularly advantageous when the workstations of the spinning machine or winder each comprise a pneumatic package loading device, including one pneumatic cylinder each. Bobbins for winding or rewinding yarn on spinning machines or winders are generally driven by drive rollers via frictional engagement. The contact pressure of the package onto the drive roller or of the drive roller onto the package is an essential factor, in this case, both for the winding process itself as well as for the quality of the generated packages. The desired contact pressure is also dependent, for example, on the properties of the yarn to be wound, the winding parameters, and the utilized empty tubes. The described pneumatic cylinder is utilized for applying the desired contact pressure onto the package and, in addition, for damping vibrations which may arise. During the course of the winding process, the circumference and the weight of the package change depending on the amount of wound yarn, and so the package contact pressure can change during the course of the winding cycle. The described pneumatic cylinder can at least partially compensate for these changes depending on the geometric conditions at the workstation or can also bring about changes of the contact pressure during the course of the winding cycle.

For the most constant working conditions of the pneumatic cylinders possible, it is advantageous in this connection when the pneumatic cylinders are each connected to one of the pneumatic devices. Preferably, several of the pneumatic cylinders are connected to a common pneumatic device. For example, all pneumatic cylinders of a section or of one section side are connected to a common pneumatic device, so that one pneumatic device is provided for each section side, as described above. It is also conceivable, of course, to combine multiple pneumatic cylinders into one group and, in turn, to assign a common pneumatic device to the group. The number of pneumatic cylinders in a group can be less than or greater than the number of pneumatic cylinders of a section or of a section side. In any case, as a result, identical conditions are obtained at all pneumatic cylinders of a group, and so different applications are possible at the workstations, for example, even in a group-wise manner.

The pneumatic devices allow for advantageous pressure regulation, whereby the force of the pneumatic cylinders can be held constant or can also be adapted, in a controlled manner, to the variable properties of the packages (see above).

In the method according to the invention for operating a spinning machine or winder, an operating pressure is regulated in a regulating line of a pneumatic device of the spinning machine or winder. The operating pressure is measured by a manometer and is compared to at least one set value by a data processing unit.

It is provided that a first valve, which is connected to a supply line for a first pressure, or a first path of a directional control valve is opened in order to feed a pressure medium into the regulating line, and a second valve, which is connected to a surrounding atmosphere, or a second path of a directional control valve is closed in order to drain the pressure medium from the regulating line if the operating pressure is less than a first set value. In addition, the second valve or the second path is opened and the first valve or the first path is closed if the operating pressure is greater than the first set value or a second set value, wherein the first pressure is greater than the operating pressure.

The method provided here can be implemented on the spinning machine or winder with the aid of comparatively simple means, whereby an efficient and decentralized pressure regulation for operating the pneumatic elements of the spinning machine or winder is made possible.

The valve or the valves can be actuated, for example, electrically by the data processing unit. The operating pressure can be corrected downward as well as upward with the aid of the method in order to reach the set value, i.e., the desired operating pressure.

It is particularly advantageous for the method when the first valve or the first path is closed and the second valve or the second path is closed if the operating pressure is equal to the first set value or is between the first set value and the second set value. As a result, a static state sets in between the first and the second default values, for example, when the regulating line is not utilized. In this state, an opening or closing of the valve or valves does not take place, and therefore the energy consumption and wear are reduced.

It is conceivable that the two set values are calculated by establishing a target pressure or a desired operating pressure and a tolerance range.

Moreover, it is advantageous to operate a pneumatic cylinder with the aid of the operating pressure of the regulating line.

The advantageous pressure regulation within the scope of the method according to the invention allows for a precise control of the force of the pneumatic cylinder. Other components, such as a blower, can also be operated, of course, with the aid of the operating pressure of the regulating line.

In a further advantageous refinement of the method, a package is mechanically loaded with the aid of the pneumatic cylinder. As described above, the pneumatic cylinder can provide a contact pressure, which is advantageous for the winding process and the quality of the packages, and can also dampen vibrations, which may arise. Moreover, depending on the geometric arrangement of the pneumatic cylinder with respect to the package, the pneumatic cylinder can also compensate for a change of the contact pressure, which results during the course of the winding cycle due to the changes of the package diameter and weight. In addition, depending on the arrangement of the pneumatic cylinder, a contact pressure, which changes during the course of the winding cycle given a constant operating pressure, can be generated in a known way.

As described above, it is very important for the spinning machine or winder, for example, to also set identical conditions with respect to the package contact pressure at the workstations at which the same application is underway, i.e., for example, the same yarn is being produced. This is possible due to the fact that multiple pneumatic cylinders are connected to a common pneumatic device.

Further advantages of the invention are described in the following exemplary embodiments. In the drawings:

FIG. 1 shows a side view of a winding area of a spinning machine or winder,

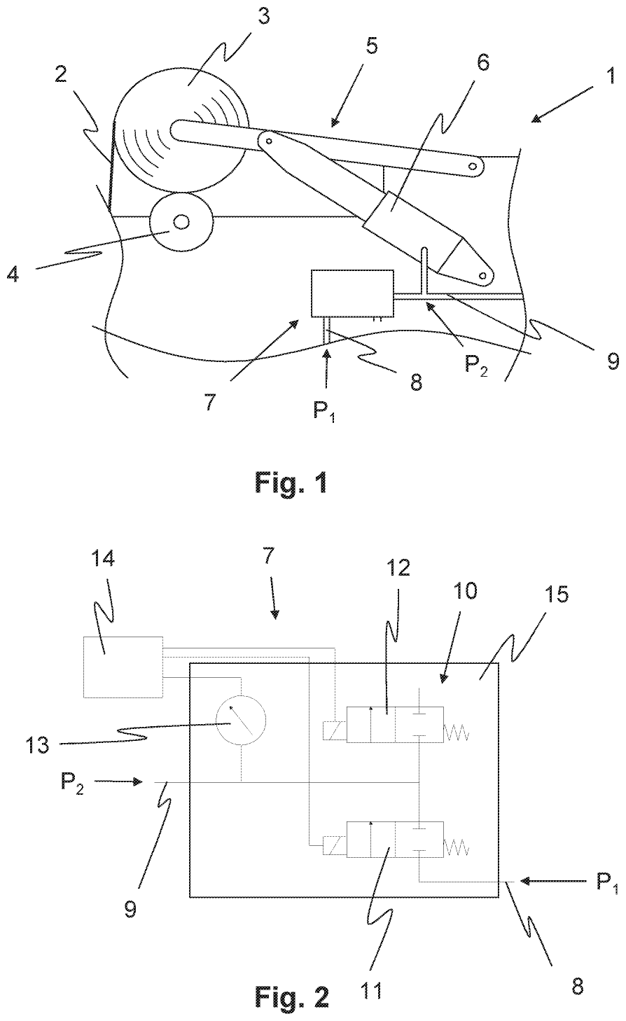

FIG. 2 shows a schematic representation of a pneumatic device according to the invention, comprising two valves, and

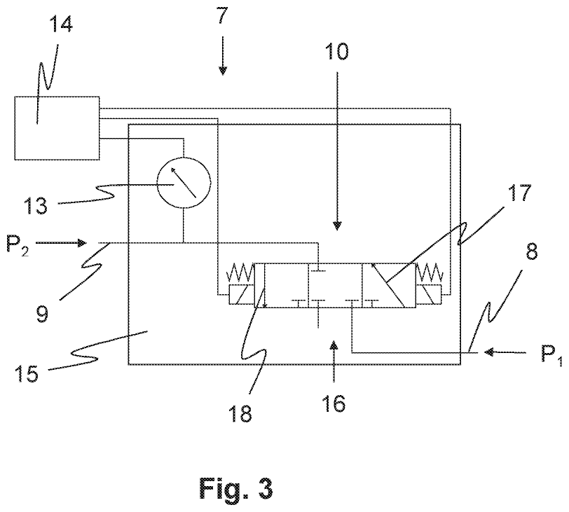

FIG. 3 shows a schematic representation of a pneumatic device according to the invention, comprising one valve.

In the following description of the figures, the same reference signs are utilized for features which are identical and/or at least comparable in each of the various figures. The individual features, their embodiment and/or mode of operation are explained in detail usually only upon the first mention thereof. If individual features are not explained in detail once more, their embodiment and/or mode of operation correspond/corresponds to the embodiment and mode of operation of the features which act in the same way or have the same name and have already been described.

FIG. 1 shows a view of a winding area of a workstation 1 of a spinning machine or winder. A thread 2 is wound onto a package 3 in this area. The thread 2 can originate, for example, from the spin box of a spinning machine, where it is produced from fibers. On a winder, the thread 2 can originate from a delivery bobbin. The package 3 is driven by a drive roller 4, wherein the weight of the package 3 acts on the drive roller 4 and, thereby, ensures a frictional engagement. As the length of the wound thread 2 increases, the weight and the circumference of the package 3 increase. A package loading device 5 is provided in order to consistently ensure a contact pressure which is advantageous for the winding process and the package quality, and in order to consistently ensure a uniform drive of the package 3. In addition, vibrations can be damped by the package loading device 5.

The package loading device 5 comprises a pneumatic cylinder 6, the piston force of which is determined by an operating pressure P₂ of a pressure medium, for example, air. The regulation of the operating pressure P₂ takes place in a pneumatic device 7, wherein the pressure medium is fed, at a first pressure P₁, to the pneumatic device 7 via a supply line 8. The pneumatic device 7 is designed in such a way that it regulates the operating pressure P₂ in a regulating line 9. This is explained in greater detail with the aid of the description of FIGS. 2 and 3. The regulating line 9 is connected to the pneumatic cylinder 6.

The regulating line 9 can be connected to further pneumatic elements (not represented) of the spinning machine or winder. The pneumatic device 7 can regulate, for example, the operating pressure P₂ for the operation of the pneumatic elements of a section of the spinning machine or winder. In particular, the pneumatic device 7 can regulate the operating pressure P₂ for the operation of the pneumatic cylinders 6 of the package loading devices 5.

A possible configuration of the pneumatic device 7 is schematically represented in FIG. 2: A valve system 10 comprises a first valve 11, which is connected to a supply line 8 for a first pressure P₁. In addition, the valve system 10 comprises a second valve 12, which is connected to a surrounding atmosphere. Both valves 11, 12 are also connected to the regulating line 9 in which the operating pressure P₂ to be regulated prevails. In this example, the valves 11, 12 are designed as uniform 2/2 directional control valves, each of which can be either open or closed.

The regulating line 9 is connected to a manometer 13, which measures the operating pressure P₂ and forwards it, as a signal, to a connected data processing unit 14. The data processing unit 14 is in control connection with the two valves 11, 12 and can open or close the valves 11, 12 independently of one another with the aid of control signals.

The data processing unit 14 compares the operating pressure P₂ transmitted by the manometer 13 to a first set value, and opens the first valve 11 and closes the second valve 12 if the operating pressure P₂ is below the first set value. In addition, the data processing unit 14 closes the first valve 11 and opens the second valve 12 if the operating pressure P₂ is above the first set value. The operating pressure P₂ is in the range between the pressure of the surrounding atmosphere and the first pressure P₁, depending on the device.

Alternatively, the data processing unit 14 can compare the operating pressure P₂ transmitted by the manometer 13 to a first set value and a second set value. In this case, the data processing unit 14 opens the first valve 11 and closes the second valve 12 if the operating pressure P₂ is below the first set value. In addition, the data processing unit 14 closes the first valve 11 and opens the second valve 12 if the operating pressure P₂ is above the second set value.

In addition, the data processing unit 14 can close both valves 11, 12 if the operating pressure P₂ is between the first set value and the second set value, whereby a static state sets in.

The two valves 11, 12, together with the manometer 13, are located on a common circuit board 15.

A further possible configuration of a pneumatic device 7 is represented in FIG. 3: A valve system 10 comprises, in this case, a directional control valve 16, which is designed as a 3/3 directional control valve 16. The other features correspond to those from FIG. 2. The directional control valve 16 has three possible switch positions, specifically a first path 17, which connects the supply line 8 to the regulating line 9, a second path 18, which connects the regulating line 9 to the surrounding atmosphere, and a neutral position, in which all connections are disconnected.

In this exemplary embodiment as well, a signal, which corresponds to the operating pressure P₂ in the regulating line 9, is fed to the data processing unit 14 by the manometer 13. With the aid of at least one electrical switch signal, the data processing unit 14 brings the directional control valve 16 into a position in which the first path 17 is open and the second path 18 is closed if the operating pressure P₂ is less than a first set value. If the operating pressure P₂ is greater than the first set value or a second set value, the data processing unit 14 brings about the assumption of a position of the directional control valve 16, in which the first path 17 is closed and the second path 18 is open.

If a pressure range between a first set value and a second set value is specified to the data processing unit 14, it is advantageous when the data processing unit 14 brings the directional control valve 16 into the neutral position or leaves the directional control valve 16 in the neutral position if the operating pressure P₂ is between the first set value and the second set value.

The present invention is not limited to the represented and described exemplary embodiments. Modifications within the scope of the claims are also possible, as is any combination of the features, even if they are represented and described in different exemplary embodiments.

### LIST OF REFERENCE SIGNS

1 workstation
2 thread
3 package
4 drive roller
5 package loading device
6 pneumatic cylinder
7 pneumatic device
8 supply line
9 regulating line
10 valve system
11 first valve
12 second valve
13 manometer
14 data processing unit
15 circuit board
16 directional control valve
17 first path
18 second path
P₁ first pressure
P₂ operating pressure

1. A spinning machine or winder comprising at least one pneumatic device (7) including a supply line (8) for a first pressure (P1), a regulating line (9) for an operating pressure (P2), a valve system (10), a manometer (13), and a data processing unit (14), wherein the regulating line (9) is connected to the manometer (13) in such a way that the operating pressure (P2) is measured by the manometer (13), characterized in that the valve system (10) comprises a first valve (11), which is connected to the supply line (8), or a first path (17) of a directional control valve (16) for feeding a pressure medium into the regulating line (9), and a second valve (12), which is connected to a surrounding atmosphere, or a second path (18) of a directional control valve (16) for draining the pressure medium from the regulating line (9),
wherein the data processing unit (14), which is connected to the manometer (13) and to the valve system (10), is designed for
opening the first valve (11) or the first path (17) and closing the second valve (12) or the second path (18) if the operating pressure (P2) is less than a first set value, and
opening the second valve (12) or the second path (18) and closing the first valve (11) or the first path (17) if the operating pressure (P2) is greater than the first set value or a second set value, wherein the first pressure (P1) is greater than the operating pressure (P2).

2-14. (canceled)
